(19) United States
(12) Patent Application Publication
(10) Pub. No.: US 2018/0101662 A1
(43) Pub. Date: Apr. 12, 2018

(54) System and Method for Processing Clinical Trial Data

(71) Applicant: Veeva Systems Inc., Pleasanton, CA (US)

(72) Inventors: Brian Longo, Danville, CA (US); Abhay Pimprikar, Campbell, CA (US); Drew Garty, Oregon, WI (US)

(73) Assignee: Veeva Systems Inc., Pleasanton, CA (US)

(21) Appl. No.: 15/629,587

(22) Filed: Jun. 21, 2017

Related U.S. Application Data
(60) Provisional application No. 62/407,399, filed on Oct. 12, 2016.

(51) Int. Cl. G06F 19/00

(52) U.S. Cl. CPC G06F 19/363; G06F 21/6245; G06F 19/3406

(57) ABSTRACT

Systems and methods for collecting medical data which may allow a sponsor to receive clinical trial data from one or more clinical trial sites electronically. A definition of a clinical trial may be generated by a sponsor and published to the one or more clinical sites. The definition of the clinical trial may define requirements and the workflow of a clinical trial. The definition may be saved as objects in the medial data management system. When users at clinical trial sites log into the medical data management system, a user interface may be generated based on one or more of the objects for receiving clinical trial source data. The clinical trial source data may be aggregated and obfuscated to remove patient defining information. The aggregated and obfuscated data may be sent to the sponsor and stored in the medical data management system as EDC data.

### CROSS-REFERENCE TO RELATED APPLICATION

This application relates and claims priority to provisional patent application No. 62/407,399, filed on Oct. 12, 2016, entitled System and Method for Collecting Medical Data, which is hereby incorporated by reference herein for all purposes.

### BACKGROUND

The subject technology relates generally to medical data management, and more particularly to processing clinical trial data.

Clinical trials are research studies on participants designed to answer specific questions about biomedical or behavioral interventions, including new treatments (such as drugs and medical devices). A clinical trial may involve a sponsor, which may be a governmental organization, or a pharmaceutical, medical device, or biotechnology company, and one or more clinical sites. Traditionally, patient clinical trial source data are captured on paper at clinical sites. The documents are collected by a sponsor, and the clinical trial source data may then be imported to an electronic data capture (EDC) system, which is a system usually owned by a sponsor and designed for the collection of clinical data in electronic format. It is desirable to improve efficiency of the process for collecting clinical trial data.

### SUMMARY

A method for processing clinical trial data comprises: enabling display of a first user interface for receiving a definition of a first clinical trial, wherein the definition of the first clinical trial defines requirements and a workflow of the first clinical trial, and wherein the definition of the first clinical trial comprises a first object and a second object. The method further comprises: receiving the definition of the first clinical trial from the first user interface; storing the definition of the first clinical trial in a first repository in a clinical trial sponsor system; enabling a first clinical trial site system and a second clinical trial site system to access the definition of the first clinical trial; and enabling display of a second user interface for receiving clinical trial source data of a first subject and a second subject, wherein the second user interface is generated based on the first object and the second object. The method further comprises: receiving clinical trial source data of the first subject and the second subject from the second user interface, wherein the clinical trial source data are correlated to the first object and the second object from the first repository in the clinical trial sponsor system. The method further comprises storing the clinical trial source data of the first subject and the second subject in the first clinical trial site system.

### BRIEF DESCRIPTION OF THE DRAWINGS

FIG. 1 illustrates an example high level block diagram of a medical data management architecture wherein the present invention may be implemented.

FIG. 2 illustrates an example block diagram of a computing device.

FIG. 3 illustrates an example high level block diagram of the medical data management server according to one embodiment of the present invention.

FIGS. 4A to 4E illustrate example user interfaces for creating or editing a study design according to one embodiment of the present invention.

FIG. 5 illustrates an example high level block diagram of a user computing device.

FIGS. 6A to 6D illustrate example user interfaces for collecting patient clinical trial source data according to one embodiment of the present invention.

FIG. 7 illustrates an example flowchart of a method for collecting medical data according to one embodiment of the present invention.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, well-known structures and components are shown in block diagram form in order to avoid obscuring the concepts of the subject technology.

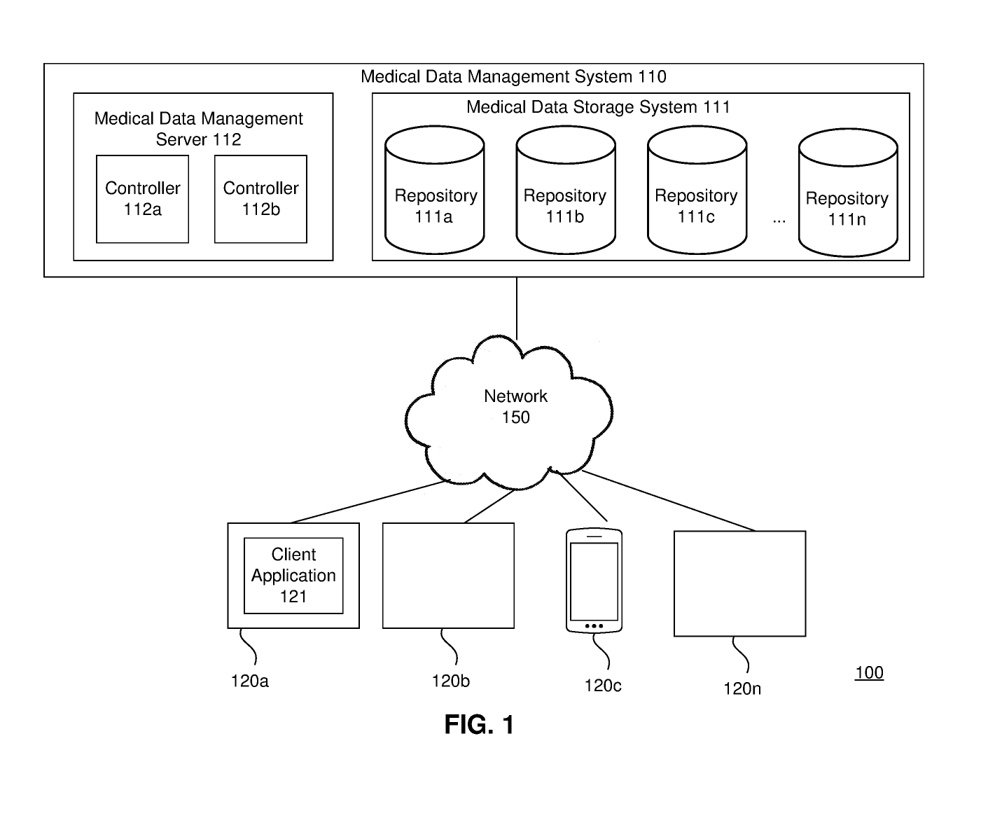

FIG. 1 illustrates an example high level block diagram of a medical data management architecture 100 wherein the present invention may be implemented. As shown, the architecture 100 may include a medical data management system 110, and a plurality of user computing devices 120a, 120b, . . . 120n, coupled to each other via a network 150. The medical data management system 110 may include a medical data storage system 111 and a medical data management server 112. The medical data storage system 111 may have two or more repositories, e.g., 111a, 111b, 111c, and 111n. The network 150 may include one or more types of communication networks, e.g., a local area network (“LAN”), a wide area network (“WAN”), an intra-network, an inter-network (e.g., the Internet), a telecommunication network, and peer-to-peer networks (e.g., ad hoc peer-to-peer networks), which may be wired or wireless.

The user computing devices 120a . . . 120n may be any machine or system that is used by a user to access the medical data management system 110 via the network 150, and may be any commercially available computing devices including laptop computers, desktop computers, mobile phones, smart phones, tablet computers, netbooks, and personal digital assistants (PDAs). A client application 121 may run from a user computing device, e.g., 120a, and access data in the medical data management system 110 via the network 150.

The medical data storage system 111 may store medical data that client applications (e.g., 121) in user computing devices 120a-120n may access and may be any commercially available storage devices. Each content repository (e.g., 111a, 111b or 111n) may store a specific category of data, and allow users to interact with its data in a specific business context. It should be appreciated that content repositories may be separate logic sections in a same storage device.

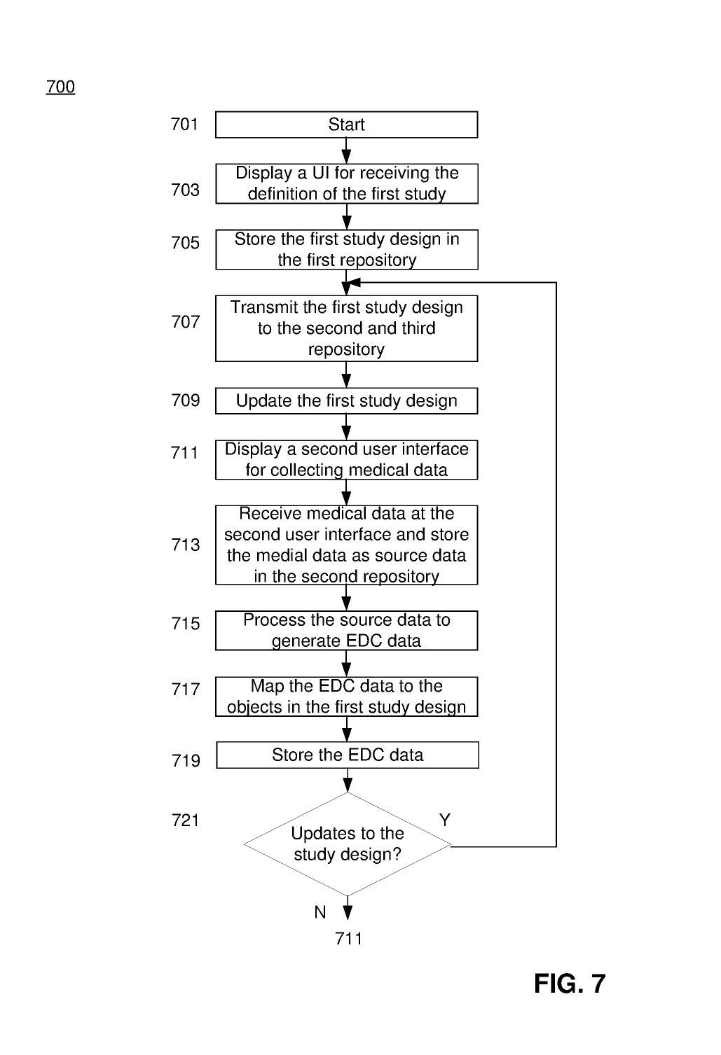

The medical data management server 112 is typically a remote computer system accessible over a remote or local network, such as the network 150. The medical data management server 112 may store a medical data management controller 112a and a medical data collection controller 112b for controlling management and collection of the medical data, including the method to be discussed with FIG. 7. The medical data management server 112 could be any commercially available computing devices. Although only one server is shown, it should be appreciated and the medical data management system 110 may have a plurality of servers and the controllers 112a and 112b may be in separate servers. A client application (e.g., 121) process may be active on one or more user computing devices 120a-120n. The corresponding server process (e.g., 112a and 112b) may be active on the medical data management server 112. The client application process and the corresponding server process may communicate with each other over the network 150, thus providing distributed functionality and allowing multiple client applications to take advantage of the information-gathering capabilities of the medical data management system 110.

In one implementation, the architecture 100 may be used for collecting and managing medical data, e.g., clinical trial data. A first repository (e.g., 111a) may be used by a first sponsor (e.g., a pharmaceutical company) to store a first study design received from a first user computing device (e.g., 120a). The first study design may define the infrastructure and lifecycle of the study, and may comprise rules (e.g., for queries, derived values, notifications and displaying events, forms and items), a casebook (i.e., a doctor's binder), event groups, events (e.g., patient visits), forms which comprise segregate sections and fields, item groups and items. In one example, a study design may define a particular study, i.e., each patient may have ten visits, and each visit may have three forms. There may be a workflow associated with each visit, e.g., what needs to be done at each visit.

In one implementation, the first study design may be stored as definition objects in the first repository 111a, specifying what is required to happen on each site during the study. The first repository 111a may also store electronic records of the first study. In one implementation, the electronic records may be EDC data. Patient clinical trial source data may be captured at the user computing devices, and the aggregated and obfuscated data may be stored as EDC data in the first repository 111a. The medical data management system 110 may have an interface for receiving EDC data collected in clinical trials and a reporting tool for analysis of the EDC data.

The second repository 111b may be used by a first site (e.g., a hospital) of the first study to store clinical trial source data from a second user computing device (e.g., 120b), and a third repository (e.g., 111c) may be used by a second site of the first study to store clinical trial source data from a third user computing device (e.g., 120c). The clinical trial source data (e.g., three blood pressure values of a patient taken during one visit) in the second repository 111b may be converted to EDC data (e.g., the average of the three blood pressure values) automatically, and then stored in the first repository 111a as EDC data. Similarly, the clinical trial source data in the third repository 111c may be converted to EDC data automatically, and then stored in the first repository 111a as EDC data. In one implementation, the clinical trial source data may be converted to the EDC data at the client application 121, and the EDC data is transmitted to the medical data management server 112. In one implementation, the clinical trial source data may be transmitted to the repository 111b or 111c via the medical data management server 112, and converted to the EDC data at the medical data management server 112. The EDC data is then stored in the repository 111a. Data in the second repository 111b and the third repository 111c may be synchronized with that in the first repository 111a regularly or from time to time when new data entries are received from user computing devices. The first study design may be transmitted to the second repository 111b and the third repository 111c. The second repository and the third repository may be synchronized with the first repository for updates to the first study design.

In one implementation, the medical data management system 110 may be a multi-tenant system where various elements of hardware and software may be shared by one or more customers. For instance, a server may simultaneously process requests from a plurality of customers (e.g., sponsors, and clinical sites), and the medical data storage system 111 may store content for a plurality of customers (e.g., sponsors, and clinical sites). In a multi-tenant system, a user is typically associated with a particular customer. In one example, a user could be an employee of one of a number of pharmaceutical companies or clinical trial sites which are tenants, or customers, of the medical data management system 110.

In one embodiment, the medical data management system 110 may run on a cloud computing platform. Users can access content on the cloud independently by using a virtual machine image, or purchasing access to a service maintained by a cloud database provider.

In one embodiment, the medical data management system 110 may be provided as Software as a Service (“SaaS”) to allow users to access the medical data management system 110 with a thin client.

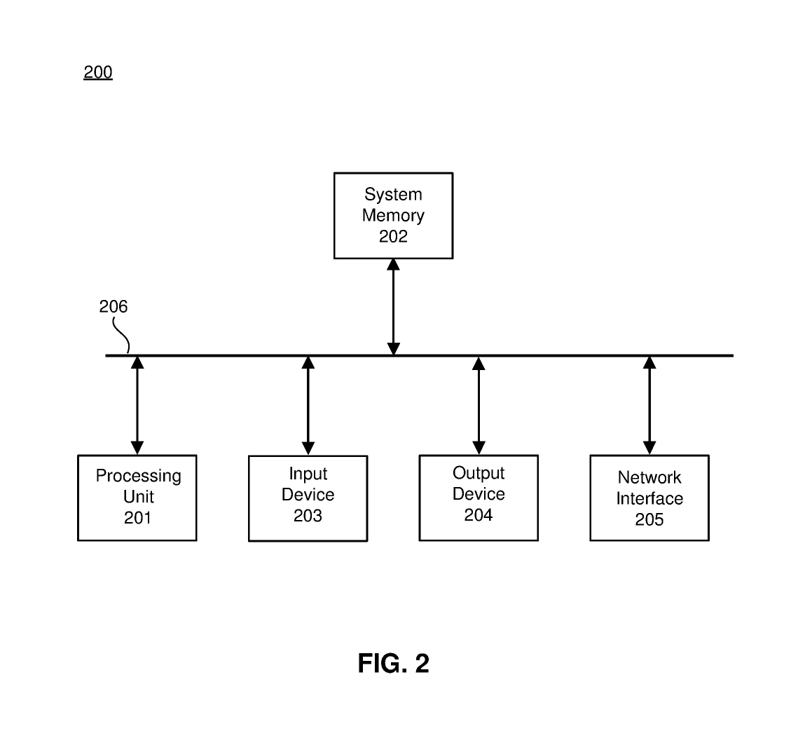

FIG. 2 illustrates an example block diagram of a computing device 200 which can be used as the user computing devices 120a-120n, and the medical data management server 112 in FIG. 1. The computing device 200 is only one example of a suitable computing environment and is not intended to suggest any limitation as to scope of use or functionality. The computing device 200 may include a processing unit 201, a system memory 202, an input device 203, an output device 204, a network interface 205 and a system bus 206 that couples these components to each other.

The processing unit 201 may be configured to execute computer instructions that are stored in a computer-readable medium, for example, the system memory 202. The processing unit 201 may be a central processing unit (CPU).

The system memory 202 typically includes a variety of computer readable media which may be any available media accessible by the processing unit 201. For instance, the system memory 202 may include computer storage media in the form of volatile and/or nonvolatile memory such as read only memory (ROM) and/or random access memory (RAM). By way of example, but not limitation, the system memory 202 may store instructions and data, e.g., an operating system, program modules, various application programs, and program data.

A user can enter commands and information to the computing device 200 through the input device 203. The input device 203 may be, e.g., a keyboard, a touchscreen input device, a touch pad, a mouse, a microphone, and/or a pen.

The computing device 200 may provide its output via the output device 204 which may be, e.g., a monitor or other type of display device, a speaker, or a printer.

The computing device 200, through the network interface 205, may operate in a networked or distributed environment using logical connections to one or more other computing devices, which may be a personal computer, a server, a router, a network PC, a peer device, a smart phone, or any other media consumption or transmission device, and may include any or all of the elements described above. The logical connections may include a network (e.g., the network 150) and/or buses. The network interface 205 may be configured to allow the computing device 200 to transmit and receive data in a network, for example, the network 150. The network interface 205 may include one or more network interface cards (NICs).

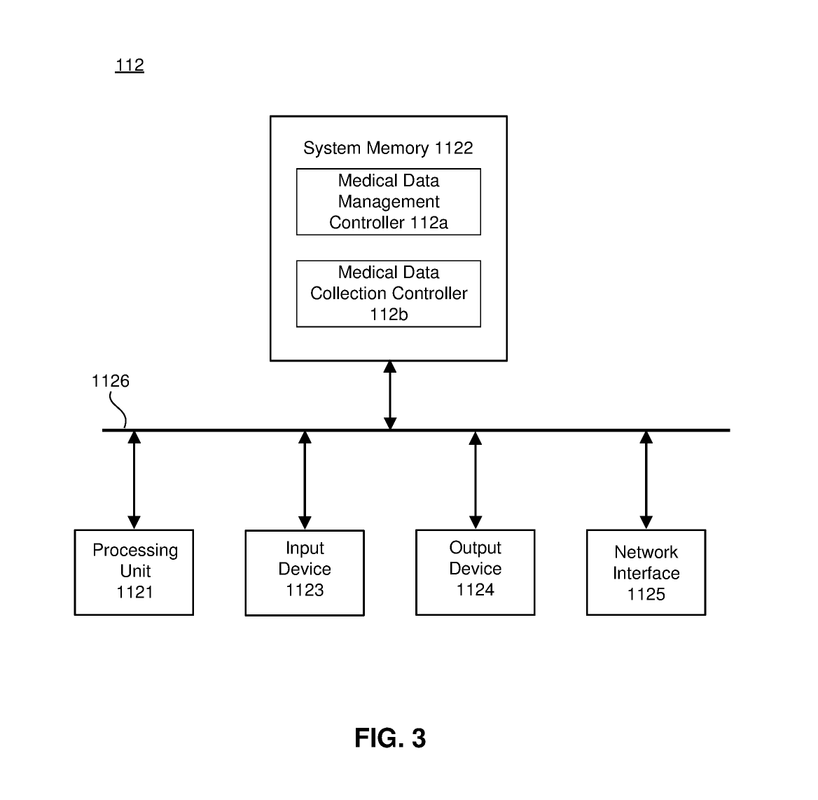

FIG. 3 illustrates an example high level block diagram of the medical data management server 112 according to one embodiment of the present invention. The medical data management server 112 may be implemented by the computing device 200, and may have a processing unit 1121, a system memory 1122, an input device 1123, an output device 1124, and a network interface 1125, coupled to each other via a system bus 1126. The system memory 1122 may store a medical data management controller 112a and/or a medical data collection controller 112b.

In one implementation, the medical data management controller 112a may be a Java application. A sponsor user may design a clinical study via the medical data management controller 112a and store the study design as definition objects in a repository (e.g., 111a). A study design may have multiple elements, including a casebook, groups, events (e.g., patient visits), and forms which include sections, item groups, items, and fields to be filled out.

In one example, a clinical trial is designed to evaluate patient response to a blood pressure medication. Participants on the medication may visit a clinical trial site three times a week for consecutive six weeks. A workflow may be designed for each visit, and may include forms to be filled out, and measurements to be taken. In one example, a participant's blood pressure may be measured three times during each visit, stored in the medical data storage system (e.g., the repository 111b) as clinical trial source data, and synchronized with other repositories in the medical data storage system 111 (e.g., the repository 111a for the sponsor). In one implementation, only aggregated and obfuscated data, without patient defining information, are sent to the sponsor repository 111a and stored there as the EDC data.

A study design may have its own lifecycle. Once a sponsor completes a study design, a workflow may be executed to publish the study design to the participating clinical trial sites (e.g., by storing the study design in clinical trial site repositories 111b and 111c) and the clinical trial may enter its execution stage. If the study design is amended during the execution stage, the updates may be sent to the participating clinical trial sites (e.g., by synchronizing the updates down to the clinical trial site repositories 111b and 111c) for them to follow.

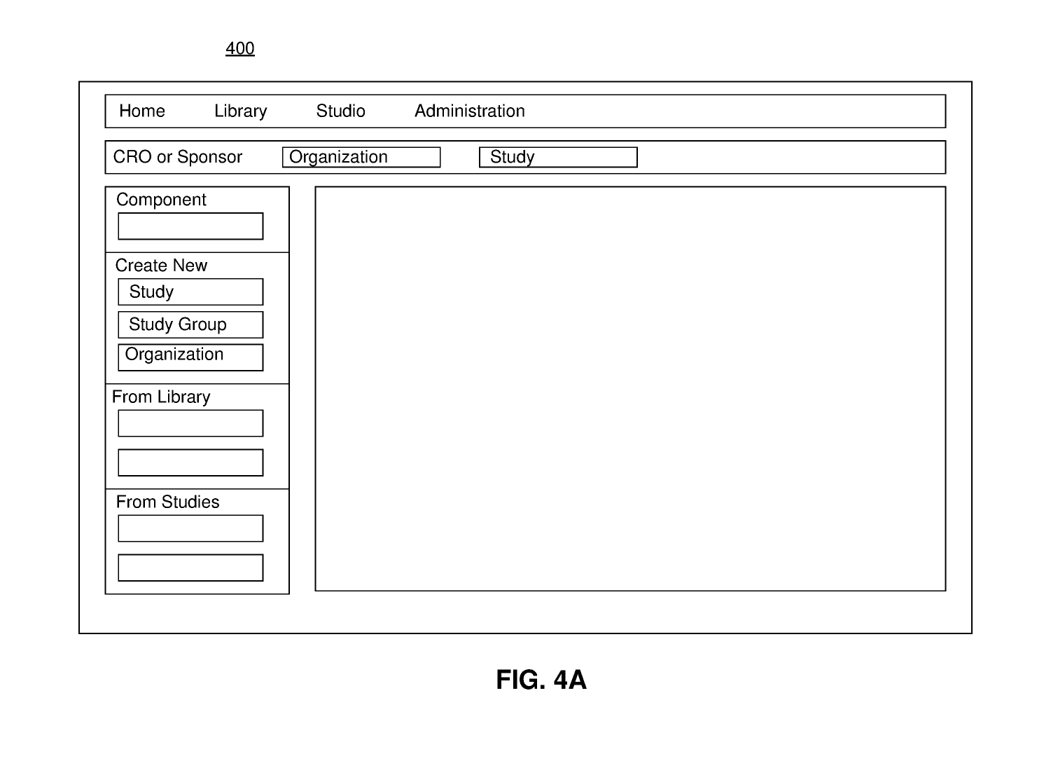

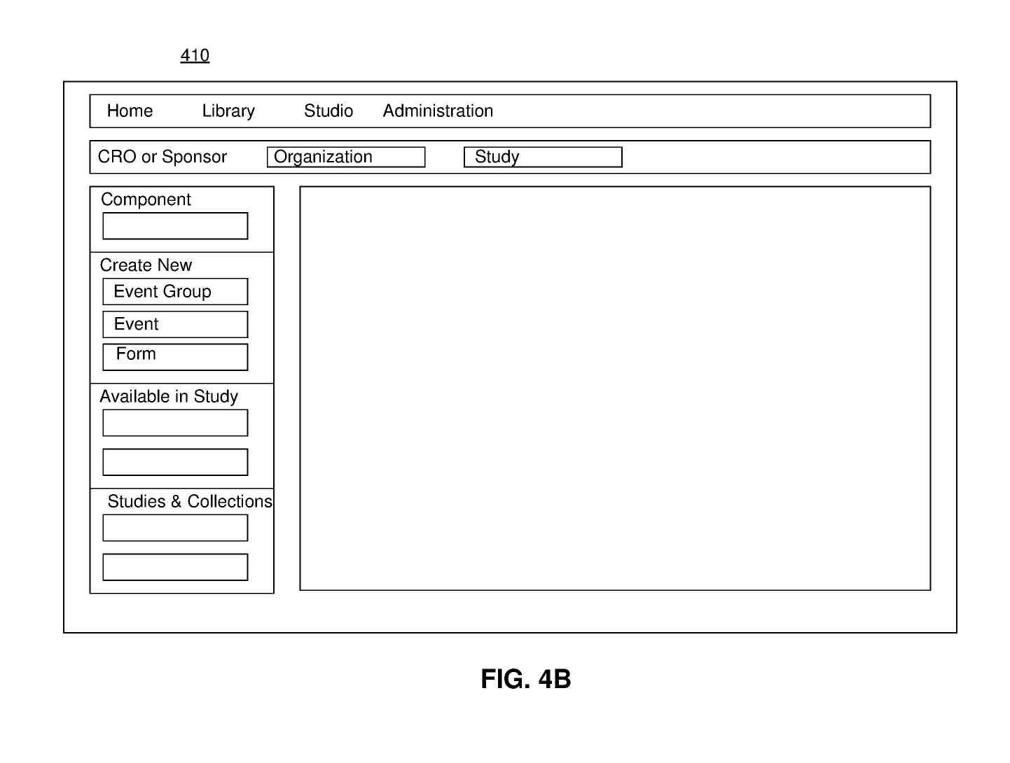

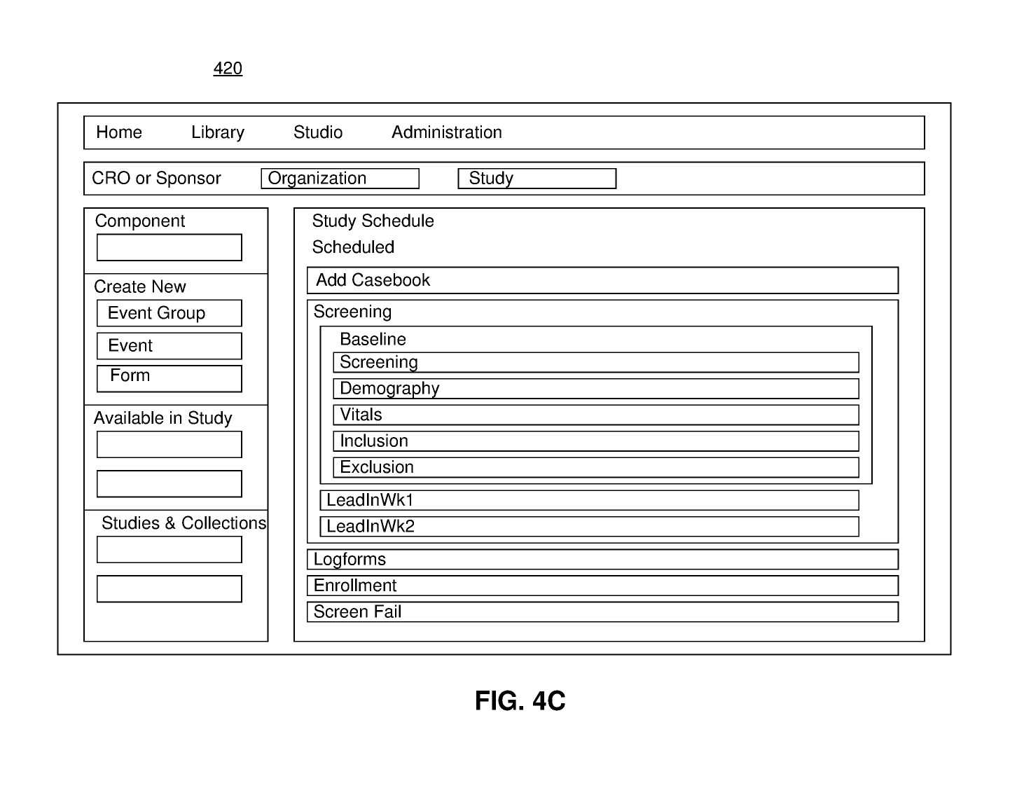

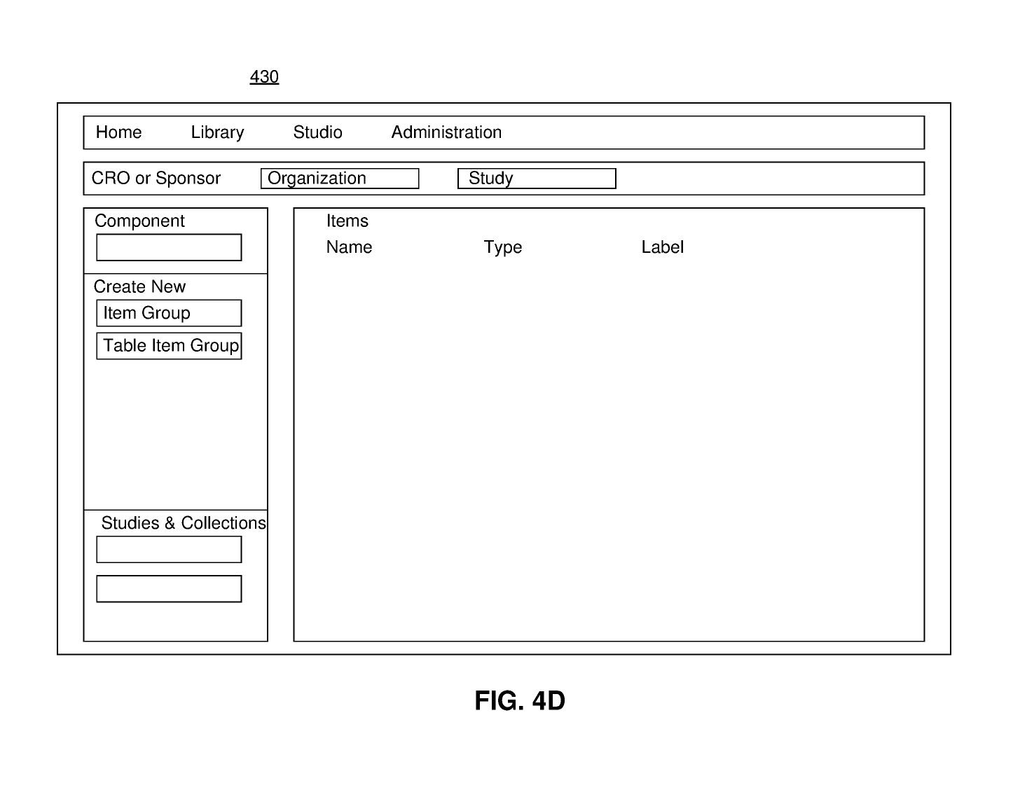

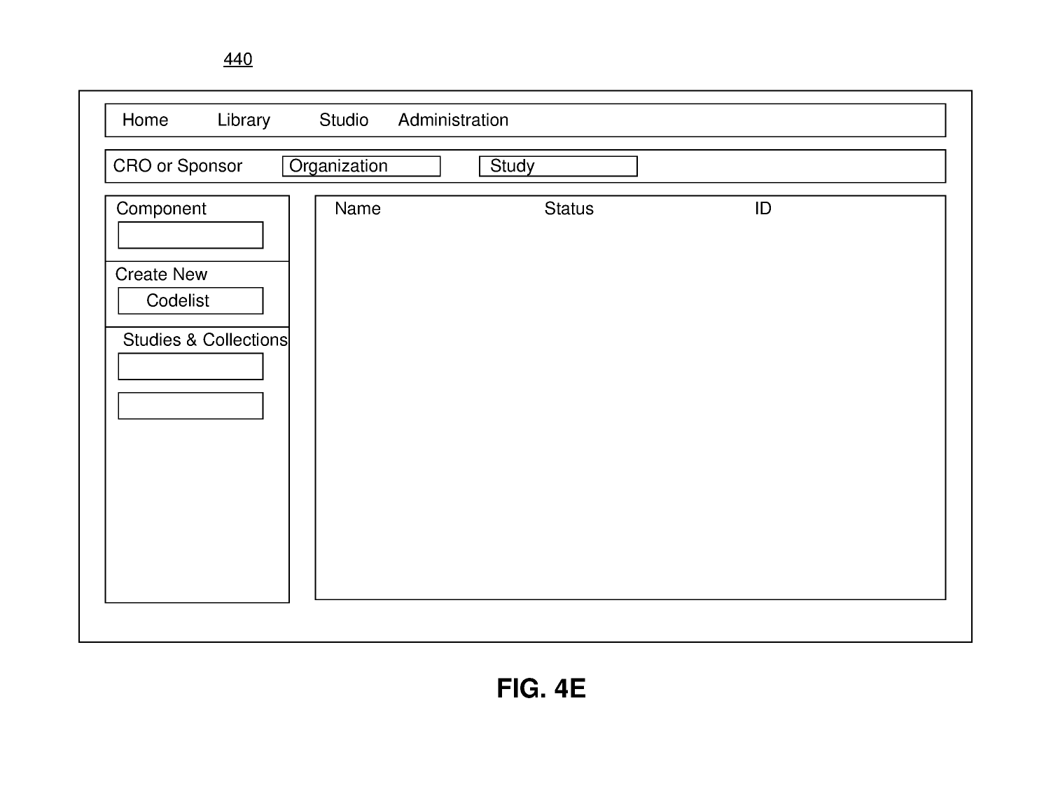

FIGS. 4A to 4E illustrate example user interfaces for creating or editing a study design according to one embodiment of the present invention. As shown, in response to a user input, the medical data management controller 112a may present a user interface 400 in FIG. 4A for creating a new study, study group or organization; a user interface 410 in FIG. 4B for creating an event group, event or form; a user interface 420 in FIG. 4C for creating an object; a user interface 430 in FIG. 4D for creating an item group; and a user interface 440 shown in FIG. 4E for creating a codelist.

The study design may be stored in the medical data management system 110 (e.g., the repository 111a) as objects. A few examples of the objects are described below:

1. FORM_DEF

FORM_DEF is the design object for all Forms.

| Field | Type | Description |
|---|---|---|
| Id | System | Unique identifier for the |
| | | record |
| name | System - Text | Name for the record |
| | 128 | |
| status | System - | Active vs. Inactive |
| | Picklist | |
| description | Text 255 | Description of the Form. |
| help_content | N/A | Stored in translation table. |
| | | Hover text help text for the |
| | | item. |
| prev_version | Object | Self-Reference record when a |
| | (form_def) | version of the record is |
| | | created. Creates duplicate |
| | | and duplicate points to |
| | | the original |
| form_status | Picklist | Defines whether the item is |
| | | published or in progress or |
| | | under review - Full list of |
| | | picklist values contained in |
| | | table Data Types table. |
| scheduled | boolean | Boolean on whether the form |
| | | is scheduled or unscheduled. |
| change_reason | Text 255 | Reason for change, if a |
| | | change is made. |
| OID | Text 100 | ODM Id for loading in via |
| | | ODM standards |
| pagelayout_xml | N/A | Defines that there will be a |
| | | corresponding XML that |
| | | defines the layout of the |
| | | Form. |
| label | N/A | Stored in translation table |
| study | Object | Reference to the study that |
| | (study_v) | is the context of the |
| | | design. |

2. FORM_DEF_ITEMGROUP_DEF

FORM_DEF_ITEMGROUP_DEF is the design Intersection object between Form and Item Group. It enables the system to understand what Sections should appear on a Form that is part of a visit.

| Field | Type | Description |
|---|---|---|
| id | System | Unique identifier for the |
| | | record |
| name | System - | System generated autonumber |
| | Autonumber | |
| status | System - | Active vs. Inactive |
| | Picklist | |
| parent | Parent Object | Parent object of |
| | (Form_Def) | interesection record. |
| child | Parent Object | Second parent object of |
| | (ItemGroup_Def) | intersection record. |
| repeat_max | Number | Number of times a repeating |
| | | question can be captured. |
| order_num | Number | Order number to display the |
| | | Forms when recording an |
| | | Event |
| change_reason | Text 255 | Reason for change, if a |
| | | change is made. Trigger |
| | | logic on object to prevent |
| | | a change if the status_vdc |
| | | is published and this field |
| | | isn't populated on a change. |
| OID | Text 100 | ODM Id for loading in via |
| | | ODM standards |
| mandatory | Boolean | Defines if the record is |
| | | mandatory. |
| label | N/A | Stored in translation table |
| study | Object (study_v) | Reference to the study that |
| | | is the contest of the design. |
| casebook_def | Object | Reference to the version of |
| | (casebook_def) | the Casebook_Def. |

3. EVENT_DEF

EVENT_DEF is the design object for events (visits). A visit will require that multiple forms be filled out.

| Field | Type | Description |
|---|---|---|
| id | System | Unique identifier for the record |
| name | System - | Name for the record |
| | Text 128 | |
| status | System - | Active vs. Inactive |
| | Picklist | |
| description | Text 255 | Description of the Event |
| event_status | picklist | Defines whether the item is |
| | | published or in progress or under |
| | | review - Full list of picklist |
| | | values contained in table Data |
| | | Types table. |
| help_content | N/A | Stored in translation table. |
| | | Hover text help text for the |
| | | item. |
| event_type | picklist | Type of event - Baseline, Visit |
| | | 1, etc. |
| repeat_max | number | Number of times that an event can |
| | | be repeated. Can be used for |
| | | unscheduled events and putting a |
| | | cap on the number of these. |
| prev_version | Object | Self-Reference record when a |
| | (event_def) | version of the record is created. |
| | | Creates duplicate and duplicate |
| | | points to the original |
| scheduled | boolean | Boolean on whether the event is |
| | | scheduled or unscheduled. |
| change_reason | Text 255 | Reason for change, if a change is |
| | | made. Trigger logic on object to |
| | | prevent a change if the |
| | | status_vdc is published and this |
| | | field isn't populated on a change. |
| OID | Text 100 | ODM Id for loading in via ODM |
| | | standards |
| label | N/A | Stored in translation table |
| study | Object | Reference to the study that is |
| | (study_v) | the context of the design. |

4. EVENT_DEF_FORM_DEF

It is the Design Intersection object between Event and Form, and enables the system to understand what Forms should appear on a visit.

| Field | Type | Description |
|---|---|---|
| id | System | Unique identifier for the record |
| name | System - | System generated autonumber |
| | Autonumber | |
| status | System. - | Active vs. Inactive |
| | Picklist | |
| parent | Parent Object | Parent object of interesection |
| | (Event_Def) | record. |
| child | Parent Object | Second parent object of |
| | (Form_Def) | intersection record. |
| change_reason | Text 255 | Reason for change, if a change |
| | | is made. Trigger logic on object |
| | | to prevent a change if the |
| | | status_vdc is published and this |
| | | field isn't populated on a |
| | | change. |
| label | N/A | Stored in translation table |
| OID | Text 100 | ODM Id for loading in via ODM |
| | | standards |
| mandatory | Boolean | Defines if the record is |
| | | mandatory. |
| order_num | Number | Order number to display the |
| | | Forms when recording an Event |
| repeat_max | Number | The limit that the form can be |
| | | repeated for this event. |
| | | Null if there is no max. |
| study | Object | Reference to the study that is |
| | (study_v) | the context of the design. |
| casebook_def | Object | Reference to the version of the |
| | (casebook_def) | Casebook_Def. |

5. CASEBOOK_DEF

It is the design object for casebook, which is a set of visits that are expected to be used to collect information for a specific patient.

| Field | Type | Description |
|---|---|---|
| id | System | Unique identifier for the record |
| name | System - | Name for the record |
| | Text 128 | |
| status | System - Picklist | Active vs. Inactive |
| description | Text 255 | Description of the Event |
| casebook_status | picklist | Defines whether the item is |
| | | published or in progress or under |
| | | review - Full list of picklist |
| | | values contained in table Data |
| | | Types table. |
| help_content | N/A | Stored in translation table. |
| | | Hover text help text for the |
| | | item. |
| casebook_type | picklist | Type of casebook |
| prev_version | Object | Self-Reference record when a |
| | (casebook_def) | version of the record is created. |
| | | Creates duplicate and duplicate |
| | | points to the original |
| change_reason | Text 255 | Reason for change, if a change is |
| | | made. Trigger logic on object to |
| | | prevent a change if the |
| | | status_vdc is published and this |
| | | field isn't populated on a change. |
| OID | Text 100 | ODM Id for loading in via ODM |
| | | standards |
| label | N/A | Stored in translation table |
| study | Object | Reference to the study that is |
| | (study_v) | the context of the design. |

6. ITEM_[STUDYID]

It is the execution object. Stores the data that is captured. A separate ITEM Table will be created per Study.

| Field | Type | Description |
|---|---|---|
| id | System | Unique identifier for |
| | | the record |
| name | System - Text 128 | Name for the record. |
| | | Copied from Item_Def. |
| status | System - Picklist | Active vs. Inactive |
| itemgoup | Parent Object | Parent record |
| | (Itemgroup) | |
| item_def | Object (Item_def) | Relationship to the |
| | | design record |
| value | Text 1500 | Captured value |
| value_translated | Text 1500 | Translated value of the |
| | | value |
| codelist_items_def | Object | Reference to the design |
| | (codelist_items_def) | record for a selected |
| | | codelist item. |
| codelist_code | Text 100 | Codelist code that was |
| | | selected |
| codelist_label | Text 255 | Codelist label |
| | | (display) that was |
| | | selected |
| unit_ref | Text 100 | Units Reference - Base |
| | | Unit for translated |
| | | value |
| unit_value | Text 100 | Units Value - Unit that |
| | | was selected |
| rev_sdv | Boolean | Review for SDV |
| rev_sdr | Boolean | Review for SDR |
| rev_dmr | Boolean | Review for DMR |
| rev_sign | Boolean | Review for Signature |
| rev_frozen | Boolean | Review for Frozen |
| rev_locked | Boolean | Reivew for Locked |
| change_reason | Text 255 | Reason for change, if a |
| | | change is made. |
| | | Trigger logic on object |
| | | to prevent a change if |
| | | the status_vdc is |
| | | published and this |
| | | field isn't populated |
| | | on a change. |
| study | Object (Study_v) | Relationship to Study |
| | | record. Copied down for |
| | | performance and query |
| | | execution. |
| subject | Object (Subject) | Relationship to Subject |
| | | record. Copied down for |
| | | performance and query |
| | | execution. |
| site | Object (Site_v) | Relationship to Site |
| | | record. Copied down for |
| | | performance and query |
| | | execution |
| casebook | Object | Realatoinship to the |
| | (CaseBook_vdc) | Casebook record. |
| | | Copied down for |
| | | performance and query |
| | | execution. |
| item_status | Picklist | Current status of the |
| | | Item - completed, in |
| | | progress, reviewed, |
| | | verified |

7. ITEMGROUP

It is the execution object, and stores that a question was answered in a particular section (ItemGroup) and the section has a status.

| Field | Type | Description |
|---|---|---|
| id | System | Unique identifier for the |
| | | record |
| name | System - | Name of the record. Copied |
| | Text 128 | from ItemGroup_Def. |
| status | System - | Active vs. Inactive |
| | Picklist | |
| itemgroup_status | picklist | Current status of the |
| | | ItemGroup - completed, in |
| | | progress, reviewed, verified |
| form | Parent Object | Parent record |
| | (Form) | |
| itemgroup_seq | Number | Sequence of the Item Group in |
| | | the case that it repeated |
| itemgroup_def | Object | Relationship to the design |
| | (Itemgroup_def) | record |
| repeat_key | Text | This is a unique identifier |
| | | for a repeating item group |
| | | within a form (generally a |
| | | table). This is related to |
| | | both itemgroup_seq_vdc and |
| | | external ID. |
| rev_sdv | Boolean | Review for SDV. System |
| | | maintained field that is the |
| | | aggregate of all of the Items |
| | | in the Item Group. |
| rev_sdr | Boolean | Review for SDR. System |
| | | maintained field that is |
| | | theaggregate of all of the |
| | | Items in the Item Group. |
| rev_dmr | Boolean | Review for DMR. System |
| | | maintained field that is the |
| | | aggregate of all of the Items |
| | | in the Item Group. |
| rev_sign | Boolean | Review for Signature. System |
| | | maintained field that is the |
| | | aggregate of all of the Items |
| | | in the Item Group. |
| rev_frozen | Boolean | Review for Frozen. System |
| | | maintained field that is the |
| | | aggregate of all of the Items |
| | | in the Item Group. |
| rev_locked | Boolean | Review for Locked. System |
| | | maintained field that is the |
| | | aggregate of all of the Items |
| | | in the Item Group. |
| study | Object | Relationship to Study record. |
| | (Study_v) | Copied down for performance |
| | | and query execution. |
| subject | Object | Relationship to Subject |
| | (Subject) | record. Copied down for |
| | | performance and query |
| | | execution. |
| site | Object | Relationship to Site record. |
| | (Site_v) | Copied down for performance |
| | | and query execution |
| casebook | Object | Realatoinship to the Casebook |
| | (CaseBook_vdc) | record. Copied down for |
| | | performance and query |
| | | execution. |
| change_reason | Text 255 | Reason for change, If a |
| | | change is made. Trigger logic |
| | | on object to prevent a change |
| | | if the status_vdc is |
| | | published and this field |
| | | isn't populated on a change. |

The objects may be used and transferred across all parts in the architecture 100 shown in FIG. 1, including a sponsor system (e.g., the medical data management controller 112a and the repository 111a), the sites (e.g., the medical data collection controller 112b and the repository 111b or 111e), and the user computing devices 120a, 120b to 120n. As will be discussed below with reference to FIG. 7, the user interfaces in the architecture 100 may be generated based on the objects, and data processing and mapping in the architecture 100 may be based on correlation of the objects as well.

An example of an item VV-000061 is shown below:
VV000061 Active
   Created by: John Smith
   Created date: January 1, 20xx
   Last Modified by: John Smith
   Last Modified Date: March 1, 20xx
   Casebook: SCR-0001
   Event: VV-000011
   Form: VV-000021
   Item Definition: 901-Initials
   Item Status: Blank
   Item Group: VV-000023
Review for CFR
   Review for DMR
   Review for Frozen
   Review for MMR
   Review for SDR
   Review for SDV
   Review for Signature
   Subject: SCR-0001
   Unit Value:
   Value: NMJ
   Value Translated
      Site: 201
      Study: Vofen
      Study Country: Vofen
      Union: VV-000011
   Review for locked
   Value Normalized
   Item Group Definition: Creation Criteria
   Form Definition: Demographics
   Event Definition: Screening Visit

The definitions may be correlated and stored in the medical data storage system 111 as structured data. One example is shown as follows:

| | | Form | Event | Item |
|---|---|---|---|---|
| Name | Event | Definition | Definition | Definition |
| VV-000001 | VV-000001 | Demo- | Screening | 902-Date |
| | | graphics | Visit | of Birth |
| VV-000002 | VV-000001 | Demo- | Screening | 901-Initialts |
| | | graphics | Visit | |
| VV-000005 | VV-000001 | Exclusion | Screening | 004-Pregnant |
| | | Criteria | Visit | |
| VV-000009 | VV-000001 | Inclusion | Screening | 007-ECG |
| | | Criteria | Visit | |
| VV-000021 | VV-000002 | Adverse | Common Log | AESTDTC |
| | | Events | Forms | |

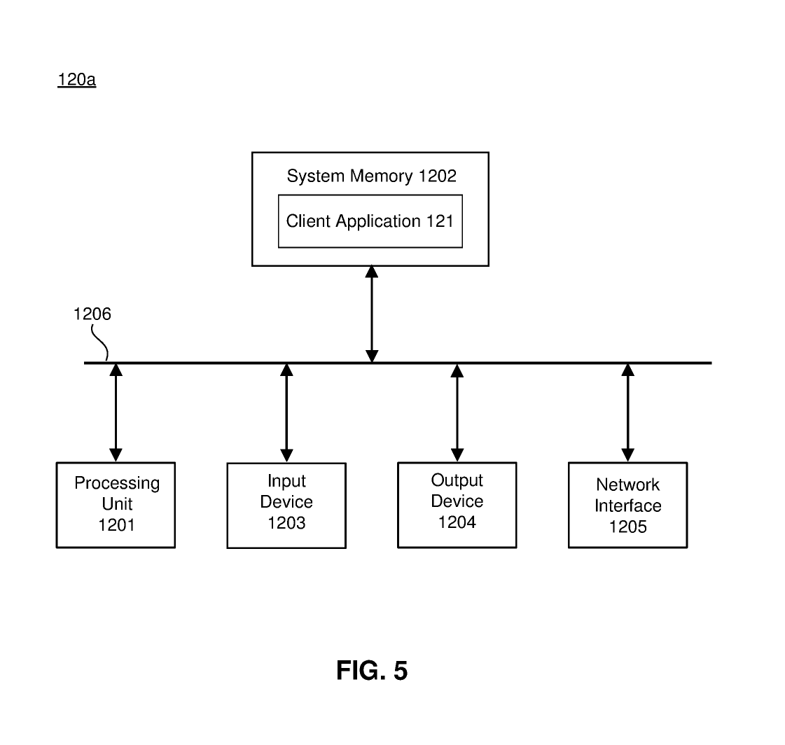

FIG. 5 illustrates an example high level block diagram of a user computing device (e.g., 120a) wherein the present invention may be implemented. The user computing device 120a may be implemented by the computing device 200 described above, and may have a processing unit 1201, a system memory 1202, an input device 1203, an output device 1204, and a network interface 1205, coupled to each other via a system bus 1206. The system memory 1202 may store the client application 121.

The client application 121 may be an application installed on a computing device, or a web application. Users at a clinical trial site may enter patient clinical trial information via the client application 121, and the clinical trial source data may be stored in a repository (e.g., 111b).

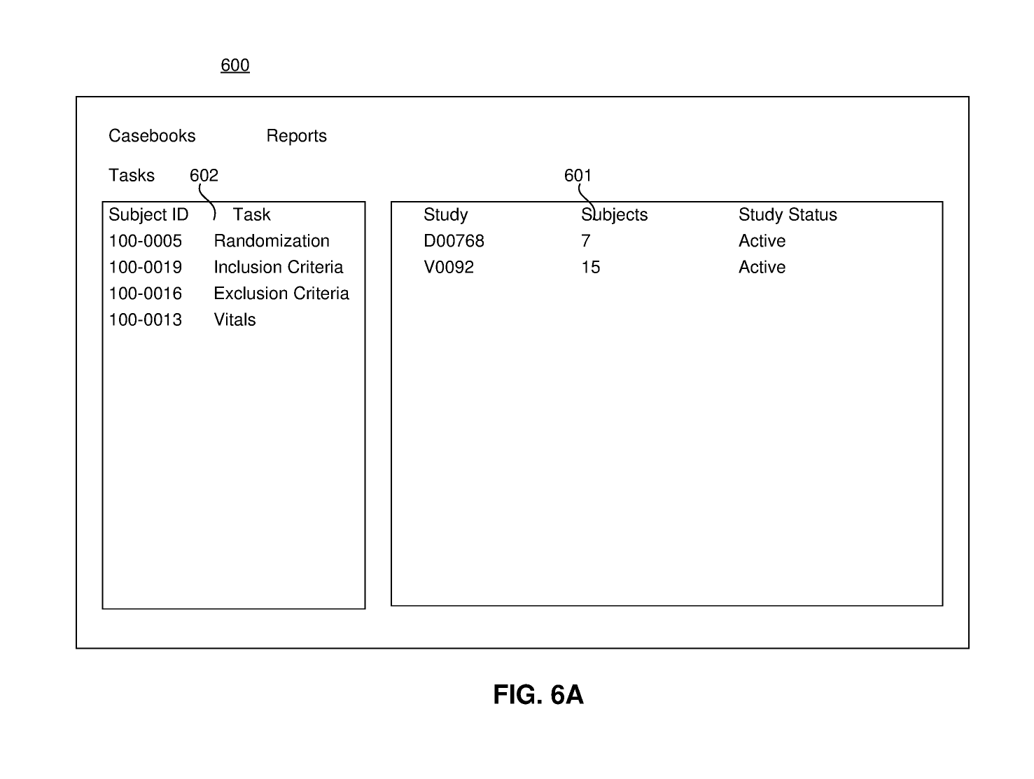

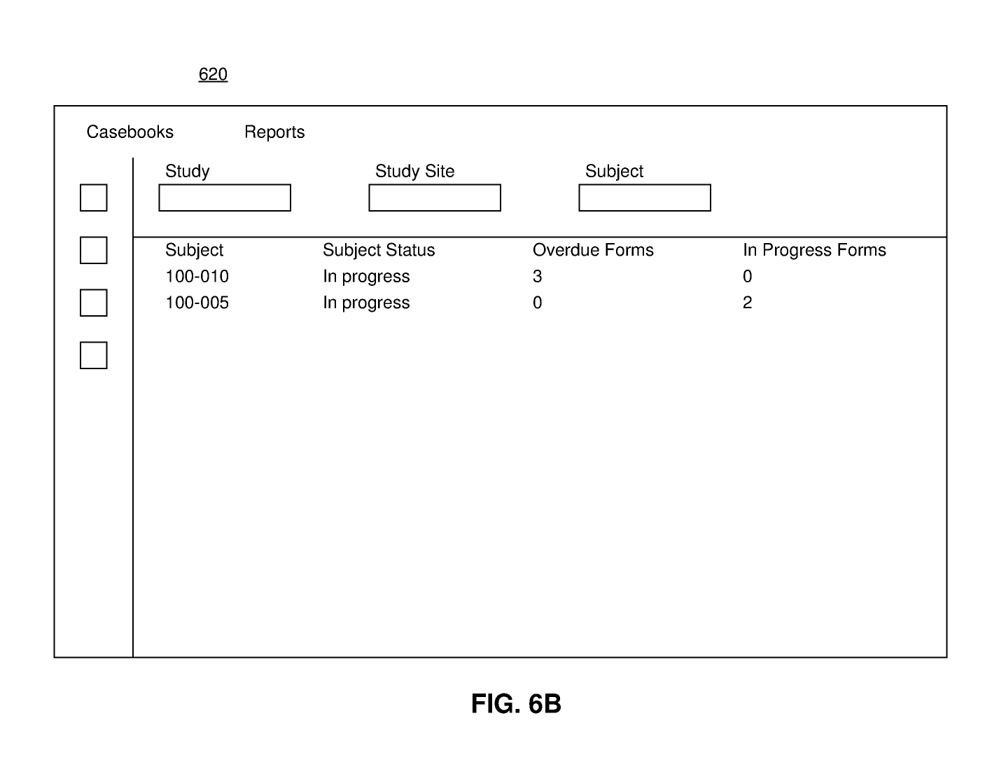

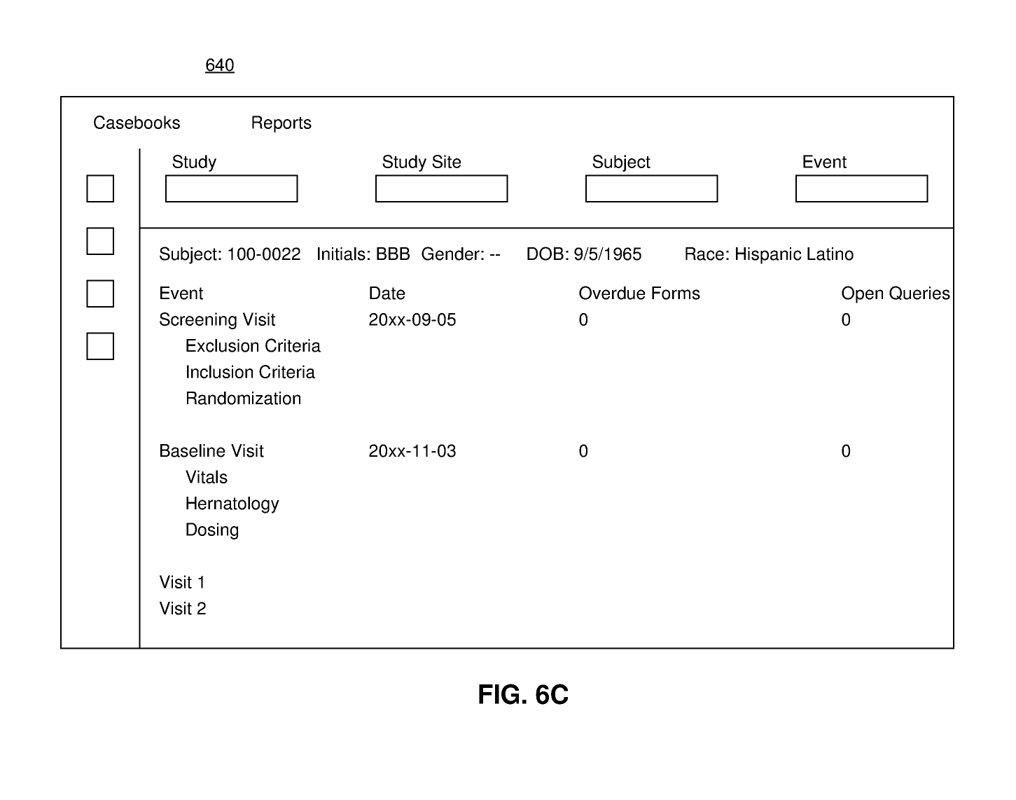

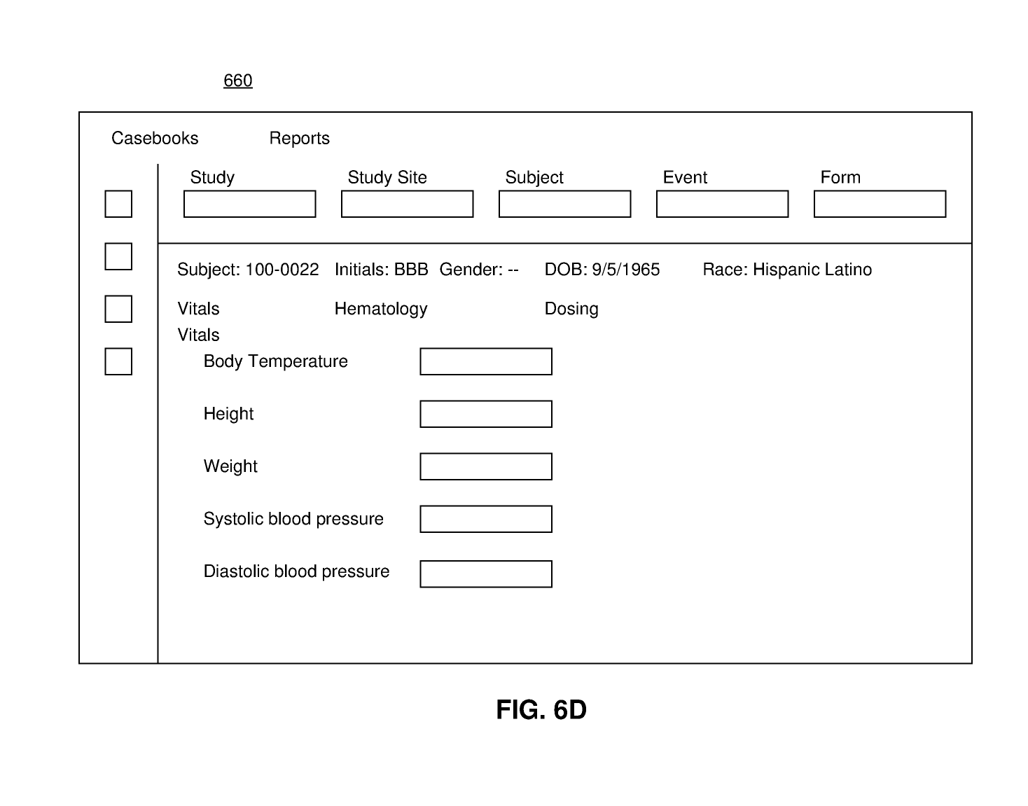

FIGS. 6A to 6D illustrate example user interfaces for collecting patient clinical trial information according to one embodiment of the present invention. During the execution stage of a clinical trial, when a clinical trial site user logs into the medical data management system 110, a user interface 600 may be generated based on one or more objects of the definition of the first clinical trial and clinical trial source data previously stored in the medical data storage system 111. The user interface 600 may have an area 601 for displaying clinical trials the site user is working on, and an area 602 for displaying clinical trial tasks he/she needs to take actions on, e.g., overdue forms and queries they need to respond to.

When the site user selects a clinical trial from the area 601, a user interface 620 shown in FIG. 6B may be displayed, which may have a list of the subjects of the clinical trial, and their status, including overdue forms and in progress forms.

When the site user selects a subject, a user interface 640 shown in FIG. 6C may be displayed, which may have some biographic information the subject provided (e.g., date of birth, gender and race), a list of all his/her visits, and forms that have been filled out. The subjects may come in on a regular basis, and receive their medication. It may take a measurement on how they are performing as part of the clinical trial. The data will be aggregated up to determine if the product is effective and safe.

When the site user starts or selects a visit, a clinical trial form user interface 660 shown in FIG. 6D may be displayed. The clinical trial site user may enter data on the clinical trial form user interface 660. For example, based upon the information just captured, the clinical site user may put into the vital forms 98.6 for temperature, 72 for height, and 200 for weight. When there is Internet access, the data may be sent to the repository 111b, and a little icon may show up to indicate that the data is stored in real time. In one embodiment, the clinical trial source data may be checked for obvious mistakes, e.g., data in a wrong field, and data out of reasonable range. The data validation may be done at the client application 121. Once the site user submits the form, the information becomes locked. Alternatively, the data validation may be done at the medical data collection controller 112b.

The clinical trial site user may navigate through the user interfaces, and go to any point in the hierarchy and any subject in the study. The site user may fill out the information, and go to the next subject, without having to change the context and the event in the form that he/she is filling out.

The user interfaces 600, 620, 640 and 660 may be generated based on one or more objects in the definition of the first clinical trial. In one implementation, the user interfaces may be generated by the medical data management controller 112a, and sent to the clinical trial sites and user computing devices. In one implementation, the user interfaces may be generated by the medical data collection controller 112b based on the objects in the definition of the first clinical trial from the medical data management controller 112a, and sent to the user computing devices. In one implementation, the user interfaces may be generated by the user computing device, e.g., 120b, based on the objects in the definition of the first clinical trial from the medical data management controller 112a or the medical data collection controller 112b.

FIG. 7 illustrates a flowchart of a method for collecting medical data according to one embodiment of the present invention.

The process may start at 701.

At 703, a user interface, e.g., the user interface 400 shown in FIG. 4A, may be generated for accepting definition of a first study design from a sponsor user. In one implementation, the medical data management controller 112a may enable display of the user interface 400 on a sponsor user computing device (e.g., 120a) for accepting definition of the first study design.

At 705, the first study design may be received at the medical data management controller 112a from the user computing device 120a and stored in the medical data management system 110, e.g., the repository 111a for the sponsor. The first study design may define one or more forms for each visit, and each form may include information such as a patient's demographic information (e.g., name, Date of Birth, race and gender) and clinical trial source data to be collected. The first study design may also define events and the sequence of the events, which may include screening events, enrollment, medical history, repeating frequency of visits depending on the protocol, and workflow of each visit (e.g., administering medication and taking one or more measurements on a predetermined schedule). Each form may have a number of boxes for receiving data. The definitions, elements or items (e.g., Date of Birth) may be used across the sponsor system, all clinical trial site systems and user computing devices, and flow back and forth in the architecture 100 shown in FIG. 1. In one example, the study is to monitor blood pressure response to a medication, and may require a number of visits according to a predetermined schedule and a blood pressure value for each visit. As discussed above, the first study design may be stored in the medical data management system 110 (e.g., the repository 111a) as various objects, including FORM_DEF, FORM_DEF_ITEMGROUP_DEF, EVENT_DEF, EVENT_DEF_FORM_DEF, CASEBOOK_DEF, ITEM_[STUDYID] and ITEMGROUP.

At 707, the first study design may be published and transmitted to sites involved. In one implementation, the study design may be stored in, e.g., the repository 111b for a first participating site and the repository 111c for a second participating site. In one example, the repository 111b and the repository 111c may be authenticated before the first design study can be transmitted to it.

In one implementation, clinical trial forms, e.g., the clinical trial form shown in FIG. 6D, may be generated at the medical data management controller 112a based on objects in definition of the first study design and sent to the clinical trial site repositories (e.g., 111b and 111c).

At 709, the first study design may be updated or expanded, e.g., by the medical data collection controller 112b in the first clinical trial site system. For example, the first study definition from the sponsor's medical data management controller 112a may require a blood pressure value, and the object maybe, e.g., 901-Initial. The definition may be updated at the medical data collection controller 112b to use the average of three blood pressure values during one visit as the blood pressure value required by the first study definition, and the objects may be 901-Initial-2, 901-Initial-3 and 901-Initial-Calculated. Different versions of definitions may be mapped and correlated.

At 711, a clinical trial site user may log in, and user interfaces 600, 620, 640 and 660 may be displayed while he/she is navigating through the webpages to select the study, subject, event and form. In one implementation, the user interfaces 600, 620, 640 and 660 may be generated by the medical data collection controller 112b in the first clinical trial site system based on the updated objects (e.g., 901-Initial-1, 901-Initial-2, and 901-Initial-3) and data in the medical data storage system 111, and sent to the user computing device 120b. In one implementation, the user interfaces 600, 620, 640 and 660 may be generated by the user computing device 120b based on the objects in the first study definition from the medical data management controller 112a (e.g., 901-Initial) or updated objects from the medical data collection controller 112b (e.g., 901-Initial-1, 901-Initial-2, and 901-Initial-3), and data from the medical data storage system 111.

At 713, medical data may be entered on a user interface, e.g., the user interface 660 shown in FIG. 6D, on the user computing device 120b, and stored in the repository 111b as clinical trial source data via the medical data collection controller 112b. Medical data may also be entered to the user computing device 120c, and stored in the repository 111c as clinical trial source data via the medical data collection controller 112b. In one example, during execution of the study on a site, a patient's blood pressure may be taken three times during a visit and stored in the repository 111b as clinical trial source data, e.g., 901-Initial-1, 901-Initial-2, and 901-Initial-3.

At 715, the clinical trial source data may be processed to get the EDC data. In one example, the three blood pressure values may be averaged up and obfuscated to get the EDC data. The clinical trial source data from the user computing device 120b (e.g., 110/70, 106/69, and 111/74) and corresponding to the updated objects from the medical data collection controller 112b (e.g., 901-Initial-1, 901-Initial-2, and 901-Initial-3) may be processed to get 901-Initial-Calculated (e.g., 109/71), which may then be processed into the EDC data (e.g., through obfuscation. The EDC data may include the object 901-Initial-Calculated and its value. In one implementation, the clinical trial source data may be sent to the medical data collection controller 112b and converted to the EDC data there. Alternatively, the clinical trial source data may be processed on the user computing device 120b, and the EDC data is then transmitted to the medical data management controller 112a.

At 717, the EDC data may be mapped to the objects in the first study design, e.g., the 901-Initial-Calculated may be mapped to the object 901-Initial in the definition of the first study design based on their definitions.

At 719, the EDC data may be stored in the repository 111a mapped to objects in the definition of the first study design.

At 721, it may be determined if there are any updates to the first study design. If yes, the process may return to 707 for transmitting updates to the first study design. Otherwise, the process may return to 711 to capture the medical data.

In one implementation, Jason formatted structure may be used for the data mapping to allow the data to flow back and forth across various parts in the architecture 100.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

In this specification, the term “software” is meant to include firmware residing in read-only memory or applications stored in magnetic storage, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs. Examples of computer programs or computer code include machine code, for example is produced by a compiler, and files including higher-level code that are executed by a computer, an electronic component, or a microprocessor using an interpreter.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more.

What is claimed is:

1. A computer-implemented method for processing clinical trial data, the method comprising:
enabling display of a first user interface for receiving a definition of a first clinical trial, wherein the definition of the first clinical trial defines requirements and a workflow of the first clinical trial, and wherein the definition of the first clinical trial comprises a first object and a second object;
receiving the definition of the first clinical trial from the first user interface;
storing the definition of the first clinical trial in a first repository in a clinical trial sponsor system;
enabling a first clinical trial site system and a second clinical trial site system to access the definition of the first clinical trial;
enabling display of a second user interface for receiving clinical trial source data of a first subject and a second subject, wherein the second user interface is generated based on the first object and the second object;
receiving clinical trial source data of the first subject and the second subject from the second user interface, wherein the clinical trial source data are correlated to the first object and the second object from the first repository in the clinical trial sponsor system; and
storing the clinical trial source data of the first subject and the second subject in the first clinical trial site system.

2. The method of claim 1, wherein the definition of the first clinical trial further defines a first event, and wherein the first event comprises a visit of the first subject.

3. The method of claim 2, wherein the definition of the first clinical trial further defines a workflow for the first event.

4. The method of claim 2, wherein the definition of the first clinical trial further defines a form for the first event.

5. The method of claim 1, further comprising: storing the clinical trial source data of the first subject and the second subject in a second repository in a medical data management system, and wherein the second repository is also in the first clinical trial site system.

6. The method of claim 5, further comprising: aggregating the clinical trial source data of the first subject and the second subject.

7. The method of claim 6, further comprising: obfuscating the clinical trial source data of the first subject and the second subject to remove patient defining information.

8. The method of claim 7, further comprising: storing the aggregated and obfuscated data as EDC data in the first repository in the clinical trial sponsor system.

9. The method of claim 5, further comprising: storing the definition of the first clinical trial in the second repository in the first clinical trial site system.

10. The method of claim 2, further comprising: displaying a third user interface for creating the first event.

11. The method of claim 3, further comprising: displaying a fourth user interface for creating a workflow for the first event.

12. The method of claim 2, further comprising: displaying a fifth user interface which enables navigation between information of the first clinical trial, an event and a subject.

13. The method of claim 1, further comprising: checking mistakes in the clinical trial source data for data validation.

14. The method of claim 1, further comprising: enabling the first clinical trial site system and the second clinical trial site system to access updates to the definition of the first clinical trial.

15. The method of claim 1, wherein the first user interface is on a first user computing device in the clinical trial sponsor system comprising the first repository.

16. The method of claim 1, wherein the second user interface is on a second user computing device in the first clinical trial site system comprising the second repository.

17. The method of claim 8, further comprising: mapping the EDC data to the first object and the second object in the first repository.

18. The method of claim 1, wherein the clinical trial sponsor system comprises an electronic data capture (“EDC”) system.

19. The method of claim 1, wherein the second user interface is generated at a medical data management controller in the clinical trial sponsor system based on the first object and the second object in the definition of the first clinical trial.

20. The method of claim 1, wherein the second user interface is generated at a medical data collection controller in a first clinical trial site system based on the first object and the second object in the definition of the first clinical trial.

21. The method of claim 1, wherein the second user interface is generated at the second user computing device in the first clinical trial site system based on the first object and the second object in the definition of the first clinical trial.

22. The method of claim 1, further comprising: extending the first object in the first clinical trial site system to generate a third object, wherein the first object and the third object are correlated.

23. The method of claim 22, wherein the second user interface is generated at the second user computing device in the first clinical trial site system based on the third object.

24. A system for collecting medical data, comprising:
a medical data storage system, which comprises a first repository and a second repository; and
a medical data management server for:
enabling display of a first user interface for receiving a definition of a first clinical trial, wherein the definition of the first clinical trial defines requirements and a workflow of the first clinical trial, and wherein the definition of the first clinical trial comprises a first object and a second object;
receiving the definition of the first clinical trial from the first user interface;
storing the definition of the first clinical trial in the first repository in the medical data management system;
enabling a first clinical trial site system and a second clinical trial site system to access the definition of the first clinical trial;
receiving clinical trial source data of the first subject from the first clinical trial site system, wherein the clinical trial source data are correlated to the first object and the second object from the first repository; and
storing the clinical trial source data of the first subject in the first clinical trial site system.
